(19) United States
(12) Patent Application Publication
(10) Pub. No.: US 2026/0119686 A1
(43) Pub. Date: Apr. 30, 2026

(54) AUTHORITY MANAGEMENT METHOD AND APPARATUS FOR VIDEO, AND ELECTRONIC DEVICE AND MEDIUM

(71) Applicant: Beijing Youzhuju Network Technology Co., Ltd., Pinggu District, Beijing (CN)

(72) Inventor: Li Jia, Beijing (CN)

(21) Appl. No.: 19/115,620

(22) PCT Filed: Aug. 18, 2023
(86) PCT No.: PCT/CN2023/113899

§ 371 Date: Mar. 26, 2025

(30) Foreign Application Priority Data
Sep. 26, 2022 (CN) 202211175844.0

(51) Int. Cl. G06F 21/62; G06F 21/30; H04L 51/04; H04N 21/2743

(52) U.S. Cl. CPC G06F 21/6209; G06F 21/30; H04L 51/04; H04N 21/2743; G06F 2221/2141

(57) ABSTRACT

Embodiments of the present disclosure relate to a method, an apparatus, an electronic device, and a medium for video permission management. The method comprises receiving an authorization from a first user to a second user for a permission to publish a video, wherein the first user and the second user belong to a same entity. The method further comprises receiving a video published by the second user. The method further comprises, if the received video is published by the second user on behalf of the first user, associating the received video with the first user.

### CROSS-REFERENCE TO RELATED APPLICATION(S)

The present application claims priority to Chinese Patent Application No. 202211175844.0, filed on Sep. 26, 2022 and entitled “AUTHORITY MANAGEMENT METHOD AND APPARATUS FOR VIDEO, AND ELECTRONIC DEVICE AND MEDIUM”, which is incorporated herein by reference in its entirety.

### FIELD

Embodiments of the present disclosure relate to the field of computers, and more specifically, to a method and apparatus for video permission management, an electronic device, and a medium.

### BACKGROUND

With the development of the video field (for example, short videos) and the development of network technologies, the network bandwidth is wider, users may watch videos with higher definition, and the definition of videos is also getting higher and higher. Thanks to the development of video codec technology and the development of streaming media technology, applications in the field of short videos are developing rapidly, and the number of users is also expanding.

An operating entity of a short video account usually has a plurality of streamers, each streamer operates his/her own live broadcast in his/her own style, and user inquiries generated therefrom are usually also replied by himself/herself, so as to maintain a customer relationship. Because information on the Internet spreads quickly, in such frequent and close interaction, an entity usually faces more customer service pressure, because a bad reputation will spread quickly.

### SUMMARY

Embodiments of the present disclosure provide a method, an apparatus, an electronic device, and a computer-readable storage medium for video permission management.

According to a first aspect of the present disclosure, there is provided a method for video permission management. The method includes receiving an authorization by a first user to a second user for a permission to publish a video, and the first user and the second user belong to a same entity. The method also includes receiving a video published by the second user. The method also includes, if the received video is published by the second user on behalf of the first user, associating the received video with the first user.

According to a second aspect of the present disclosure, there is provided an apparatus for video permission management. The apparatus includes a permission authorization module configured to receive an authorization by a first user to a second user for a permission to publish a video, and the first user and the second user belong to a same entity. The apparatus also includes a video receiving module configured to receive a video published by the second user. The apparatus also includes a video association module configured to, if the received video is published by the second user on behalf of the first user, associate the received video with the first user.

According to a third aspect of the present disclosure, there is provided an electronic device. The electronic device includes a processor and a memory coupled to the processor, the memory having instructions stored therein, the instructions, when executed by the processor, causing the electronic device to perform the method according to the first aspect.

According to a fourth aspect of the present disclosure, there is provided a computer-readable storage medium. The computer-readable storage medium has stored therein one or more computer instructions, wherein the one or more computer instructions are executed by a processor to implement the method according to the first aspect.

The Summary is to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The above and other features, advantages, and aspects of embodiments of the present disclosure will become more apparent in conjunction with the accompanying drawings and the following detailed description. In the drawings, the same or similar reference numerals denote the same or similar elements, wherein:

FIG. 1 shows a schematic diagram of an example environment in which the method for video permission management can be implemented according to some embodiments of the present disclosure;

FIG. 2 shows a block diagram of components of a centralized position according to some embodiments of the present disclosure;

FIG. 3 shows a schematic diagram of a centralized position display page according to some embodiments of the present disclosure;

FIG. 4 shows a flowchart of a method for video permission management according to some embodiments of the present disclosure;

FIG. 5 shows a schematic diagram of implementing private message authorization according to some embodiments of the present disclosure;

FIG. 6 shows a flowchart of a further method for video permission management according to some embodiments of the present disclosure;

FIG. 7 shows a block diagram of an apparatus for video permission management according to some embodiments of the present disclosure; and

FIG. 8 shows a block diagram of a device for video permission management according to some embodiments of the present disclosure.

Throughout the drawings, the same or similar reference numerals denote the same or similar elements.

### DETAILED DESCRIPTION OF EMBODIMENTS

It may be understood that data (including but not limited to the data itself, data acquisition or use) involved in the technical solutions of the present disclosure should comply with requirements of corresponding laws, regulations and relevant provisions.

Embodiments of the present disclosure are described in more detail below with reference to the accompanying drawings. Although some embodiments of the present disclosure are shown in the drawings, it should be understood that the present disclosure may be implemented in various forms and should not be construed as being limited to the embodiments set forth herein. On the contrary, these embodiments are provided for a more thorough and complete understanding of the present disclosure. It should be understood that the drawings and embodiments of the present disclosure are only for exemplary purposes, and are not intended to limit the scope of protection of the present disclosure.

In the description of the embodiments of the present disclosure, the term “include/comprise” and similar terms should be understood as an open inclusion, that is, “include/comprise but not limited to”. The term “based on” should be understood as “at least partially based on”. The term “an embodiment” or “the embodiment” should be understood as “at least one embodiment”. The terms “first”, “second”, and the like may refer to different or same objects. Other explicit and implicit definitions may also be included below.

The inventors have noticed that after a short video is pushed to a customer in the field of short videos, or after the customer is attracted by the video and watches the video, the customer may have a purchase behavior, or may have a behavior of following the video or following an streamer (that is, an account of the streamer). This process may be referred to as “conversion”. Traditional merchants may hire some streamers to produce videos by themselves, upload the videos, and then generate conversions. These customers attracted by the videos may send consultation questions before conversion, or establish a group discussion with a plurality of similar customers. Generally, these customers are maintained by the streamer who publishes the video. However, the streamer may not have professional knowledge of the product, resulting in a low conversion rate.

The inventors have also noticed that for an operating entity, it is necessary to establish a matrix account to increase the conversion rate. The single mechanism of “whoever publishes, whoever maintains” cannot effectively improve the conversion rate. Therefore, within the same entity, a more detailed division of labor is also required, so that more professional employees can produce and publish videos, and employees who know how to serve customers better can maintain customer relationships.

In order to solve the above drawbacks, the embodiments of the present disclosure provide a solution for video permission management. The solution can implement authorization of a permission to publish videos between employee accounts within the same entity. With the authorization mechanism of the permission, it is possible to allow more professional employees to produce and publish videos. At the same time, the video can be published on a short video page of another employee (for example, an employee with more influence). In this way, employees who produce videos may avoid using the accounts or devices of other employees to publish such videos.

In the following description, some embodiments will be discussed with reference to a short video conversion process of a hairdresser of a hair salon. However, it should be understood that this is only for the purpose of enabling those of ordinary skill in the art to better understand the principles and ideas of the embodiments of the present disclosure, and is not intended to limit the scope of the present disclosure in any way.

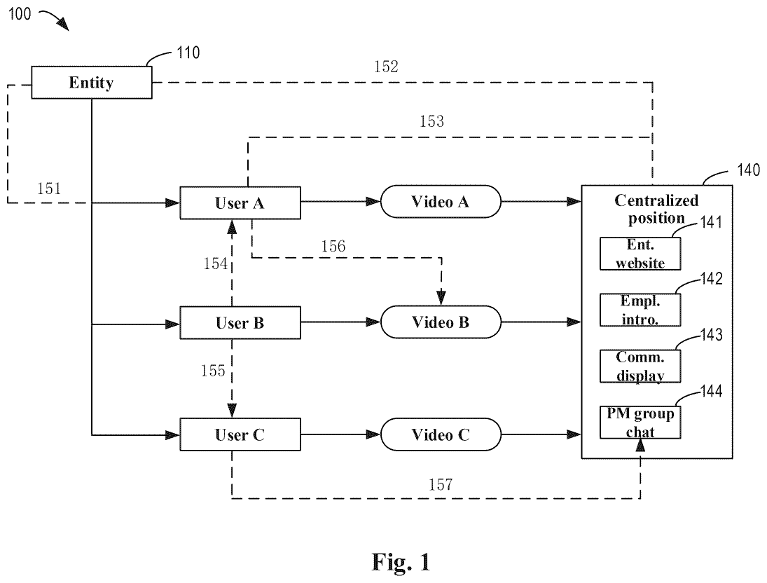

FIG. 1 shows a schematic diagram of an example environment 100 in which the method for video permission management can be implemented according to some embodiments of the present disclosure. As shown in FIG. 1, the example environment 100 may include an entity 110, which may be an enterprise, a plurality of individuals in partnership, or more generally a seller, a merchant, and the like. The entity 110 may have an enterprise account on a short video platform for publishing a video belonging to the entity 110. The entity 110 may have a plurality of employees, and each employee has his/her own personal account on the short video platform. The environment 100 also includes users, and the users may browse videos on the short video platform, or may also publish videos belonging to themselves with their own accounts, and these videos will be displayed on their own pages.

In the environment 100, a user A (also referred to as a second user), a user B (also referred to as a first user), and a user C (also referred to as a fourth user) represent registered users on the short video platform. The user A, the user B, and the user C are all employees of the entity 110. Therefore, the entity 110 may display the videos published by the user A, the user B, and the user C in a centralized position 140 (also referred to as a video aggregation page) of the entity 110 as the videos of the entity 110 via the authorization 151.

The entity 110 may also maintain the centralized position 140 via the authorization 152. Specifically, an enterprise official website 141, an employee introduction 142, a product display 143, and a private message group chat 144 in the centralized position 140 may be maintained. The enterprise official website 141 may display an introduction to the entity 110, for example, display a basic introduction, a contact address, an indoor environment, and the like of the hair salon. The employee introduction 142 may display a personal introduction and works of the user A (that is, hairdresser A). Similarly, the employee introduction 142 may also display information related to the user B and the user C.

The commodity display 143 may display commodities related to hairdressing. These commodities may be displayed in the form of a static or dynamic cover of a video. These displays have some functional components to implement functions such as private messages, follow, likes, purchase, join groups, and private messages. The private message group chat 144 implements private message interaction between the entity 110 and the customer, or interaction between the customers in the group.

In the environment 100, the user B may authorize the user A to publish a video on behalf of himself/herself via the authorization 154. After the user A is authorized to publish the video on behalf of the user B, when publishing the video, the user A may choose whether to publish his/her own video or publish the video on behalf of the user B. The user B may also be authorized by the user C to reply to the private message on behalf of himself/herself through the authorization 155.

If the entity authorizes the user A as an administrator, the user A may also maintain the centralized position through 153, for example, maintain what videos are displayed at what positions and in what form, and the like. The user A may also implement the function of using his/her own video as a video published by the user B through the authorization 156.

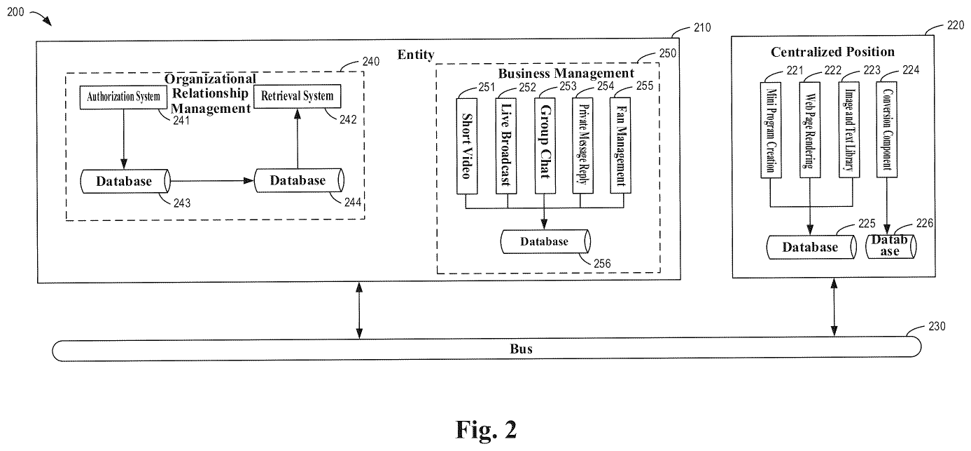

FIG. 2 shows a block diagram of components 200 of a centralized position according to some embodiments of the present disclosure. The centralized position 220 may be understood as a video aggregation page, and the customer may watch one or more videos in the video aggregation page, become interested, and thus be converted. In the background of the centralized position, there are some functional components to support the conversion.

Specifically, in the background module 210 for the entity, the entity may maintain an organization relationship management module 240 and a business management module 250. The organization relationship management module 240 includes an authorization system 241 and a retrieval system 242. In the authorization system 241, the authorization process of the authorization 151 to 156 shown in FIG. 1 may be implemented. The authorization result may be stored in a database 243 (for example, a MySQL database), and information such as an authorization relationship and an employee relationship is stored in the database 243. The database 243 may be connected to a database 244, where the database 244 may be a database dedicated to retrieval (for example, an ES (Elastic Search) database) to achieve faster retrieval. In the retrieval system 242, the retrieval result may be obtained from the database 244.

The business management module 250 may include a business module 251 for short videos, a business module 252 for live broadcasts, a module 253 for group chat, a module 254 for private message reply, and a module 255 for fan management (for example, followers, etc.). Data of these modules 251 to 255 is stored in a database 256. The business management module 250 is configured to directly support the business of the centralized position to achieve conversion.

The centralized position 220 includes a module 221 for creating a mini program, a module 222 for rendering and displaying a web page, and a picture and text library 223 for improving the display effect or serving as display materials. Data of the module 221 to the module 223 is stored in a database 225, where the database 255 is on a device of the customer, for example, in a mobile phone APP. The centralized position 224 also includes a conversion component 224 for obtaining or analyzing possible conversion clues and storing the conversion clues in a database 226. The module 210 for the entity and the centralized position 220 are both connected to a data bus 230, and the data bus 230 may be a logically data bus.

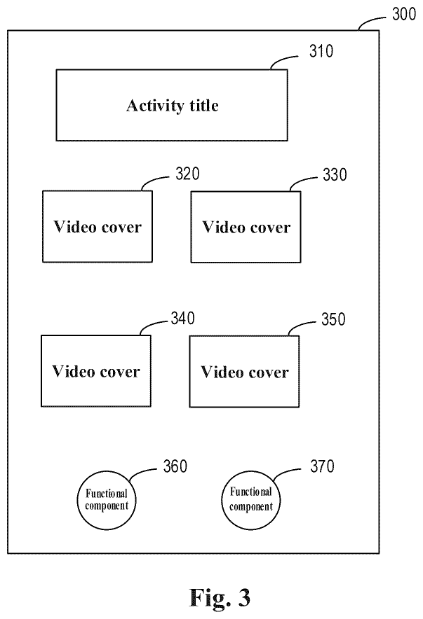

FIG. 3 shows a schematic diagram of a centralized position display page 300 according to some embodiments of the present disclosure. As shown in FIG. 3, the centralized position display page 300 is an aggregation page where the customer can see videos, and is also referred to as a video aggregation page. The centralized position may include an event title 310 and video covers 320 to 350 of a plurality of videos. The customer may click the covers to watch the video content. These video covers may also be dynamic to provide a preview of the video.

The centralized position display page 300 may also include some functional components, such as a functional component 360 and a functional component 370. The functional component 360 and the functional component 370 may provide functions such as likes, follow, private messages, group chat, and links to shopping carts. The customer may click the functional components to implement the corresponding functions. The positions of these functional components, video covers, and titles are exemplary.

In this way, the centralized position 220 may generate a customer-oriented video aggregation platform with the assistance of the background module 210. In order to improve the conversion rate, it is necessary to authorize different employees with different permissions in the background module according to the professional capabilities of different employees, especially the permissions for publishing videos and maintaining customers. Because the content of the video is the key to attract customers, in order to obtain more customers' attention, for example, to allow more customers to watch the video, add follow, etc. Better customer maintenance is the key to providing higher conversion rates. Arranging more communicative employees as customer service, for example, replying to private messages, etc. Therefore, a multi-level comprehensive authorization mechanism is required to implement the authorization of permissions for specific videos or private messages to different employees.

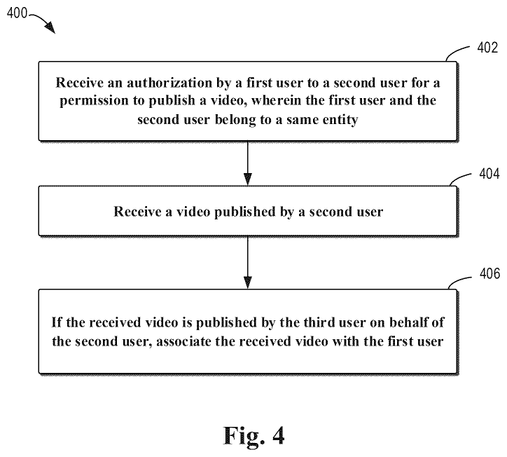

The process according to the embodiments of the present disclosure will be described in detail below in conjunction with FIGS. 4 to 6. For the convenience of understanding, the specific data mentioned in the following description are all exemplary and are not used to limit the scope of protection of the present disclosure. It can be understood that the embodiments described below may also include additional actions not shown and/or may omit the shown actions, and the scope of the present disclosure is not limited in this respect.

FIG. 4 shows a flowchart of a method 400 for video permission management according to some embodiments of the present disclosure. At block 402, an authorization by a first user to a second user for a permission to publish a video is received, and the first user and the second user belong to a same entity. For example, both the user A and the user B are employees of the hair salon, the user B is a hairdresser of the hair salon, and the user A is an employee in charge of operations. Since the user A has richer experience in video production and publishing, the user B authorizes the user A for a permission to publish the video A.

At block 404, a video published by the second user is received. As an example, the user A publishes a video A, and the background module 210 may receive the video A. At block 406, if the received video is published by the second user on behalf of the first user, the received video is associated with the first user. For example, when the user A publishes the video A, he/she may choose whether to send it as himself/herself or on behalf of the user B. In response to the video A published by the user A being published on behalf of the user B, the background module may enable the video A to be presented at a video display position of the user B as a video published by the user B.

In this way, through the authorization management mechanism, among users belonging to the same entity, the permission of authorizing other users to publish videos as themselves improves the flexibility and efficiency of video publishing.

In some embodiments, the authorization may be received from the client of the user B. The client of the user B is generally installed in his/her own device, so privacy can also be guaranteed. The user A may publish the video on behalf of the user B without logging in to the account of the user B, thereby improving the flexibility and efficiency of video publishing.

In some embodiments, the video A may be received from the client of the user A. After receiving the video A, if it is determined that the option selected by the user A is to publish the video on behalf of the user B, the video A may be marked as the video of the user B and pushed to the client of another customer (user D, also referred to as a third user), and presented at the video position of the user B. Here, the other person may not be an employee of the hair salon, and generally should be the customer group to whom the video is delivered.

In this way, the video seen by the customer is published by the user B, but the actual publisher is the user A. Since the user A has more knowledge in operation, the produced video is more attractive to customers. Therefore, the video may be made more attractive, and the conversion rate may be improved.

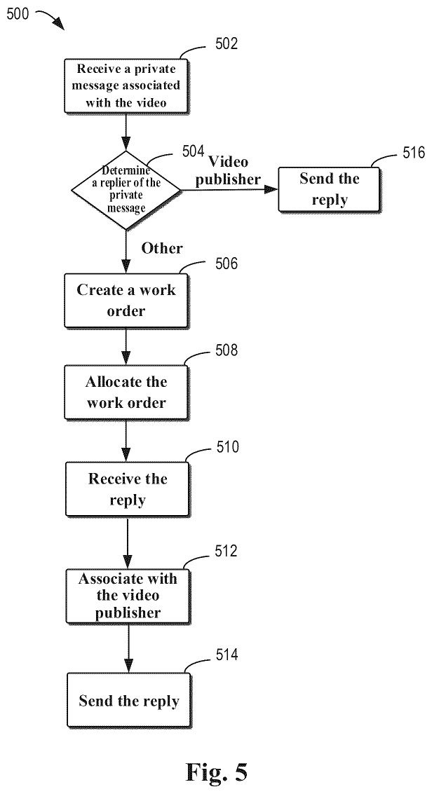

FIG. 5 shows a flowchart 500 of implementing private message authorization according to some embodiments of the present disclosure. The authorization process of the private message may be implemented with reference to the authorization 155 and the authorization 157 in FIG. 1. The authorization 155 may be understood as an authorization process for reading the private message, and the authorization 157 may be understood as an authorization process for replying to the private message.

At block 502, a private message associated with the video is received. For example, a private message mode entered by the customer is received when watching the video A and clicking the functional component 370, and the private message of the customer is forwarded to the background module 210. Since the video A is recorded and displayed as published by the user B, the user may receive the private message.

In one case, the user B has authorized the user C to reply to the private message of the user B. In another case, the user B may receive a prompt for authorization to reply to the private message. At this time, the user B may authorize the user C to reply to the private message.

At 504, a replier of the private message may be determined according to the authorization to reply to the private message. If it is determined that the private message is replied by the user B, the process proceeds to block 516, and the user B directly sends a reply to the private message to the customer. If it is determined that another customer (for example, the user D) replies to the private message, the process proceeds to block 506.

At block 506, a work order for replying to the private message may be created. At block 508, the work order may be assigned to the user C. When the user C receives the work order, he/she will know that he/she replies to the private message. At block 510, a reply from the user C to the private message may be received. At block 512, the private message is associated with the user B, that is, the publisher of the video. At block 514, the private message may be sent to the customer as a reply from the user B.

In this way, according to the authorization mechanism of replying to the private message, the private message of the user B may be forwarded to the user C, and after the user C replies, it is sent to the customer as a reply from the user B. The user C does not need to use the device of the user B, nor does he/she need to log in to the account of the user B, so privacy can be guaranteed, and the flexibility and efficiency of video publishing can be improved. At the same time, the granularity of the authorization can be refined to the level of the private message, so that the flexibility and granularity can ensure the effectiveness of replying to the private message, that is, to obtain customer satisfaction and improve the conversion rate as much as possible.

In some embodiments, a request from the user D to join a group associated with the video may also be received. For example, when the user D watches the video A, he/she clicks the functional component 360 and joins a group related to the video. Members in the group are all customers interested in the video. These customers may chat in the group and express their own opinions. There may also be employees of the hair salon in the group, for example, the user C. In response to receiving the request, the user D may be added to the group.

In this way, a shared community of videos can be established, common topics may be shared in the community, and customer relationships may be maintained by other employees in the entity where the publisher of the video is located who have more experience in customer maintenance, so that the conversion rate may be further improved.

In some embodiments, an operation of the user D following the browsed video A may also be received. After the user D follows the video A, some videos published by the user A may be recommended to the user D. Since the video A is actually published by the user A, the customer may be interested in the videos produced or published by the user A. Therefore, some videos of the user A may be recommended to the user D, thereby possibly improving the conversion rate.

In some embodiments, an authorization by the user C for maintaining a customer relationship with the user D is received, where the maintenance of the customer relationship includes the user C actively communicating with the user D, including group chat and private message chat. Such a permission allocation mechanism may allow the user A, the user B, and the user C to perform their own duties. If the capability of the employee of the entity changes in the later stage, it is also convenient to adjust the permission. In addition, the permission of the group chat or the private chat may be accurate to a single group or a single private message, so the fineness is high and the flexibility is high, so that the conversion rate can be improved.

In some embodiments, an authorization for setting the user B as an administrator may be received, and the user B is determined as the administrator. The administrator has the permission to set the user as the user of the entity, for example, adding a new employee user E (also referred to as a fifth user) to the entity 110. It also has the permission to remove the user from the entity, for example, removing the user C from the entity 110. It also has the permission to modify the permission of the user in the entity, for example, modifying the permission of the user C to reply to private messages as the permission to publish videos.

In some embodiments, the user B may also assign permissions to other users, for example, assign the permission to publish videos or the permission to reply to private messages. In this way, each employee can be controlled more precisely to do what he/she should do. In addition, the assigned permission may be adjusted flexibly as needed, and adjusted at the video level or the private message level, to meet the changing needs.

In some embodiments, in response to the expiration of the authorization, a prompt may also be sent to the user. For example, after the authorization by the user B to the user A for the permission to publish the video expires, a prompt may be sent to the user B or the user A. This is helpful for maintaining the authorization relationship more reasonably and timely, so that the authorization relationship is always maintained effectively.

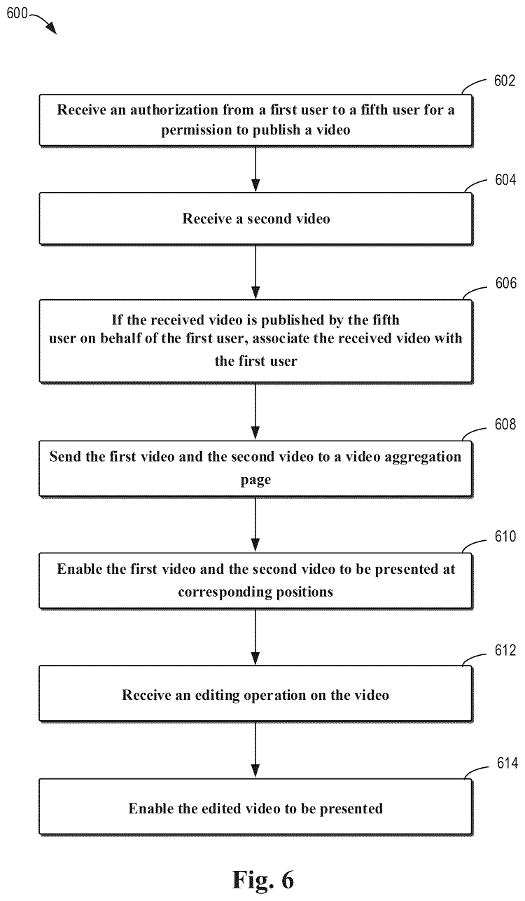

FIG. 6 shows a flowchart 600 of a further method for video permission management according to some embodiments of the present disclosure. The flowchart 600 mainly shows an authorization process of an editing permission. At block 602, an authorization from a first user to a fifth user for a permission to publish a video is received. For example, the user B authorizes the user E to publish the video.

At block 604, a second video published by the user E is received, for example, a video E. At block 606, if the received video is published by the fifth user on behalf of the first user, the received video is associated with the first user. For example, if the received video is sent by the user E on behalf of the user B, the video E may be associated with the user B.

At block 608, the first video and the second video are sent to a video aggregation page. For example, the video A and the video E are sent to the centralized position page 300. At block 610, the first video and the second video are enabled to be presented at corresponding positions. For example, the video A and the video E are presented at the video covers 320 and 330 assigned to the user B on the page 300.

At block 612, an editing operation on the video from the user B may be received, for example, an operation to modify the video A or the video E. At block 614, the edited video may be enabled to be presented on the centralized position page 300.

In this way, the permissions of publishing videos, maintaining customer relationships, and modifying and editing videos may be separated, so that professionals may do professional things. At the same time, the authorization granularity of each permission can be accurate to a single video, a single private message, and a single employee, so that the permission adjustment is more flexible and convenient. And the conversion rate is improved based on at least the above advantages.

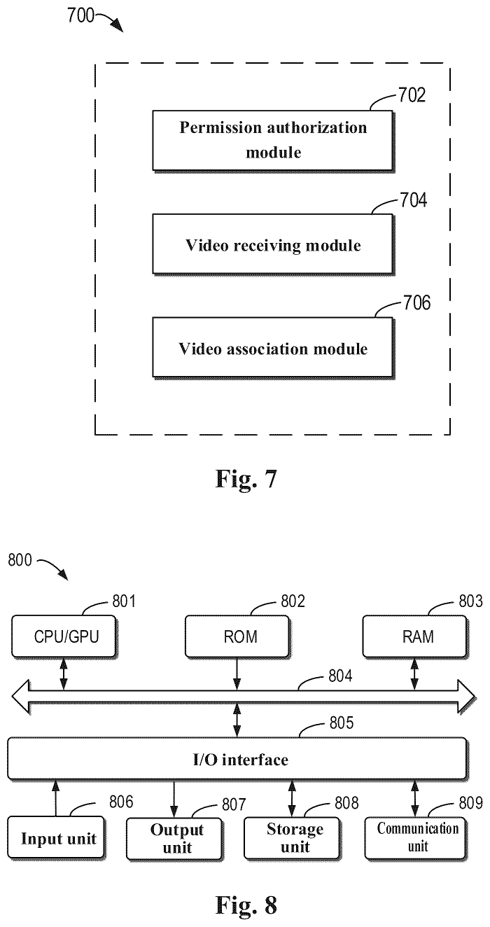

FIG. 7 shows a block diagram of an apparatus for video permission management according to some embodiments of the present disclosure. As shown in FIG. 7, the apparatus 700 includes a permission authorization module 702 configured to receive an authorization by a first user to a second user for a permission to publish a video, wherein the first user and the second user belong to a same entity. The apparatus 700 also includes a video receiving module 704 configured to receive a video published by the second user. The apparatus 700 also includes a video association module 706 configured to, if the received video is published by the second user on behalf of the first user, associate the received video with the first user. The apparatus 700 may also include other modules to implement the same functions as the method 400. For the sake of brevity, details are not described herein again.

It may be understood that the apparatus 700 of the present disclosure may implement at least one of the many advantages that can be achieved by the method or process described above. For example, among users belonging to the same entity, the permission of authorizing other users to publish videos as themselves improves the flexibility and efficiency of video publishing. For another example, the granularity of the authorization may be refined to the video level and the private message level, so that the flexibility and granularity may ensure the quality of the video, attract more customers, and the effectiveness of replying to the private message, that is, to obtain customer satisfaction and improve the conversion rate as much as possible.

FIG. 8 shows a block diagram of a device 800 for video permission management according to some embodiments of the present disclosure, and the device 800 may be a device or apparatus described in the embodiments of the present disclosure. As shown in FIG. 8, the device 800 includes a central processing unit (CPU) and/or a graphics processing unit (GPU) 801, which may perform various appropriate actions and processing in accordance with a computer program instruction stored in a read-only memory (ROM) 802 or a computer program instruction loaded from a storage unit 808 into a random access memory (RAM) 803. The RAM 803 may also store various programs and data required for the operation of the device 800. The CPU/GPU 801, the ROM 802, and the RAM 803 are connected to each other through a bus 804. An input/output (I/O) interface 805 is also connected to the bus 804. Although not shown in FIG. 8, the device 800 may also include a coprocessor.

A plurality of components in the device 800 are connected to the I/O interface 805, including: an input unit 806, such as a keyboard, a mouse, and the like; an output unit 807, such as various types of displays, speakers, and the like; a storage unit 808, such as a magnetic disk, an optical disk, and the like; and a communication unit 809, such as a network card, a modem, a wireless communication transceiver, and the like. The communication unit 809 allows the device 800 to exchange information/data with other devices through a computer network such as the Internet and/or various telecommunication networks.

The various methods or processes described above may be performed by the CPU/GPU 801. For example, in some embodiments, the method may be implemented as a computer software program which is tangibly contained in a machine-readable medium, such as the storage unit 808. In some embodiments, part or all of the computer program may be loaded and/or installed onto the device 800 via the ROM 802 and/or the communication unit 809. When the computer program is loaded into the RAM 803 and executed by the CPU/GPU 801, one or more steps or actions in the method or process described above may be performed.

In some embodiments, the above-described methods and processes may be implemented as a computer program product. The computer program product may include a computer-readable storage medium having computer-readable program instructions for performing various aspects of the present disclosure loaded thereon.

The computer-readable storage medium may be any tangible device that can retain and store instructions used by an instruction execution device. The computer-readable storage medium may be, for example but not limited to, an electrical storage device, a magnetic storage device, an optical storage device, an electromagnetic storage device, a semiconductor storage device, or any suitable combination thereof. A more specific example (non-exhaustive list) of the computer-readable storage medium would include the following: a portable computer disk, a hard disk, a random-access memory (RAM), a read-only memory (ROM), an erasable programmable read-only memory (EPROM or Flash memory), a static random-access memory (SRAM), a portable compact disk read-only memory (CD-ROM), a digital versatile disk (DVD), a memory stick, a floppy disk, a mechanical coding device, for example, a punched card or a raised structure in a groove having instructions stored thereon, and any suitable combination of the foregoing. The computer-readable storage medium described herein is not interpreted as a transient signal per se, such as radio waves or other freely propagating electromagnetic waves, electromagnetic waves propagating through a waveguide or other transmission medium (e.g., light pulses passing through a fiber-optic cable), or electrical signals transmitted through electric wires.

The computer-readable program instructions described herein may be downloaded from a computer-readable storage medium to various computing/processing devices, or downloaded to an external computer or external storage device over a network, for example, the Internet, a local area network, a wide area network, and/or a wireless network. The network may include copper transmission cables, optical fiber transmission, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium in the respective computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in one or more programming languages, where the programming languages include an object-oriented programming language and conventional procedural programming languages. The computer-readable program instructions may be executed completely or partially on a computer of a user, executed as a stand-alone software package, executed partially on a computer of a user and partially on a remote computer, or completely executed on a remote computer or server. In the case involving a remote computer, the remote computer may be connected to the computer of the user through any kind of network, including a local area network (LAN) or a wide area network (WAN), or may be connected to an external computer (for example, connected over the Internet through an Internet service provider). In some embodiments, an electronic circuit, such as a programmable logic circuit, a field programmable gate array (FPGA), or a programmable logic array (PLA), is personalized by using state information of the computer-readable program instructions, and the electronic circuit may execute the computer-readable program instructions, so that various aspects of the present disclosure are implemented.

These computer-readable program instructions may be provided to a processing unit of a general-purpose computer, a special-purpose computer, or another programmable data processing apparatus, to produce a machine, causing the instructions, when executed by the processing unit of the computer or another programmable data processing apparatus, create a device for implementing the functions/actions specified in one or more blocks in the flowcharts and/or block diagrams. These computer-readable program instructions may also be stored in a computer-readable storage medium, and these instructions enable a computer, a programmable data processing apparatus, and/or another device to work in a specific manner. Therefore, the computer-readable medium containing the instructions includes a product manufactured, which includes instructions for implementing various aspects of the functions/actions specified in one or more blocks in the flowcharts and/or block diagrams.

The computer-readable program instructions may also be loaded onto a computer, other programmable data processing apparatus, or other device, so that a series of operation steps are performed on the computer, other programmable data processing apparatus, or other device, to produce a computer-implemented process, so that the instructions executed on the computer, other programmable data processing apparatus, or other device implement the functions/actions specified in one or more blocks in the flowcharts and/or block diagrams.

The flowcharts and block diagrams in the accompanying drawings show the possible architecture, functions, and operations of the device, method, and computer program product according to a plurality of embodiments of the present disclosure. In this regard, each block in the flowchart or block diagram may represent a part of a module, program segment, or instruction, and the part of the module, program segment, or instruction contains one or more executable instructions for implementing the specified logical functions. In some alternative implementations, the functions marked in the blocks may also occur in an order different from that marked in the accompanying drawings. For example, two blocks shown in succession can actually be executed substantially in parallel, or they can sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or actions, or may be implemented by a combination of dedicated hardware and computer instructions.

The various embodiments of the present disclosure have been described above. The above descriptions are exemplary, not exhaustive, and are not limited to the disclosed embodiments. Many modifications and changes are obvious to those of ordinary skill in the art without departing from the scope and spirit of the described embodiments. The selection of the terms used herein is intended to best explain the principles of the embodiments, the practical application or the technical improvement in the market of the technology, or to enable other ordinary skilled persons in the art to understand the embodiments disclosed herein.

Some example implementations of the present disclosure are listed below.

Example 1. A method for video permission management, comprising:
receiving an authorization by a first user to a second user for a permission to publish a video, wherein the first user and the second user belong to a same entity;
receiving a video published by the second user; and
in response to the received video being published by the second user on behalf of the first user, associating the received video with the first user.

Example 2. The method according to example 1, wherein the authorization for the permission to publish the video is received from a first client of the first user, the video published by the second user is received from a second client of the second user, and the method further comprises:
sending the video published by the second user to a third client of a third user, for enabling the video published by the second user to present on a home page of the first user in the third client of the third user.

Example 3. The method according to any of examples 1-2, further comprising:
receiving an authorization by the first user to the second user for a permission to reply to a private message;
receiving a private message associated with the video published by the second user;
sending a task for replying to the private message to the second client;
receiving a reply to the private message by the second client from the second user; and
associating the reply in the private message with the first user.

Example 4. The method according to any of examples 1-3, further comprising:
receiving a request from the third user to join a group associated with the video published by the second user; and
adding the first user, the second user, and the third user to the group.

Example 5. The method according to any of examples 1-4, further comprising:
receiving an indication that the third user likes the video published by the second user; and
pushing another video published by the second user to the third user.

Example 6. The method according to any of examples 1-5, further comprising:
receiving an authorization by a fourth user of the entity for maintaining the third user; and
enabling the fourth user to maintain the interaction between the first user and the third user.

Example 7. The method according to any of examples 1-6, further comprising:
receiving an authorization for setting the first user as an administrator of the entity; and
setting the first user as the administrator of the entity, wherein the administrator has a permission to set a user as a member of the entity, a permission to remove a user from the entity, and a permission to modify a permission of the user in the entity.

Example 8. The method according to any of examples 1-7, further comprising:
in response to the authorization for the permission to publish the video having expired, sending an expiration prompt to at least one of the first user and the second user.

Example 9. The method according to any of examples 1-8, further comprising:
receiving an authorization by the first user to the second user for a permission to edit a video;
receiving an editing operation on the video from the second user; and updating information of the video according to the editing operation.

Example 10. The method according to any of examples 1-9, further comprising:
publishing the video in a video aggregation page, wherein the video aggregation page includes an introduction to the entity and a video collection.

Example 11. The method according to any of examples 1-10, wherein the video published by the second user is a first video, and the method further comprises:
receiving an authorization by the first user to a fifth user for a permission to publish a video, wherein the first user and the fifth user belong to a same entity;
receiving a second video published by the fifth user; and
in response to the second video being published by the fifth user on behalf of the first user, associating the second video with the first user.

Example 12. The method according to any of examples 1-11, further comprising:
sending the first video and the second video to the video aggregation page, enabling both the first video and the second video are presented as videos published by the first user.

Example 13. An apparatus for video permission management, comprising:
a permission authorization module configured to receive an authorization by a first user to a second user for a permission to publish a video, wherein the first user and the second user belong to a same entity;
a video receiving module configured to receive a video published by the second user; and
a video association module configured to, in response to the received video being published by the second user on behalf of the first user, associate the received video with the first user.

Example 14. The apparatus according to example 13, wherein the authorization for the permission to publish the video is received from a first client of the first user, the video published by the second user is received from a second client of the second user, and the apparatus further comprises:
a first video sending module configured to send the video published by the second user to a third client of a third user, enabling the video published by the second user to present on a home page of the first user in the third client of the third user.

Example 15. The apparatus according to any of examples 13-14, further comprising:
a second permission authorization module configured to receive an authorization by the first user to the second user for a permission to reply to a private message;
a second video receiving module configured to receive a private message associated with the video published by the second user;
a second video sending module configured to send a task for replying to the private message to the second client;
a private message reply module configured to receive a reply to the private message by the second client from the second user; and
a second video association module configured to associate the reply in the private message with the first user.

Example 16. The apparatus according to any of examples 13-15, further comprising:
a group request receiving module configured to receive a request from the third user to join a group associated with the video published by the second user; and a group adding module configured to add the first user, the second user, and the third user to the group.

Example 17. The apparatus according to any of examples 13-16, further comprising:
an indication receiving module configured to receive an indication that the third user likes the video published by the second user; and
a video pushing module configured to push another video published by the second user to the third user.

Example 18. The apparatus according to any of examples 13-17, further comprising:
a third permission authorization module configured to receive an authorization by a fourth user of the entity for maintaining the third user; and
a maintenance interaction module configured to cause the fourth user to maintain the interaction between the first user and the third user.

Example 19. The apparatus according to any of examples 13-18, further comprising:
a fourth permission authorization module configured to receive an authorization for setting the first user as an administrator of the entity; and
an administrator setting module configured to set the first user as the administrator of the entity, wherein the administrator has a permission to set a user as a member of the entity, a permission to remove a user from the entity, and a permission to modify a permission of the user in the entity.

Example 20. The apparatus according to any of examples 13-19, further comprising:
a permission prompt module configured to, in response to the authorization for the permission to publish the video having expired, send an expiration prompt to at least one of the first user and the second user.

Example 21. The apparatus according to any of examples 13-20, further comprising:
a fifth permission authorization module configured to receive an authorization by the first user to the second user for a permission to edit a video;
an editing operation receiving module configured to receive an editing operation on the video from the second user; and
a video updating module configured to update information of the video according to the editing operation.

Example 22. The apparatus according to any of examples 13-21, further comprising:
a video aggregation module configured to publish the video in a video aggregation page, wherein the video aggregation page includes an introduction to the entity and a video collection.

Example 23. The apparatus according to any of examples 13-22, wherein the video published by the second user is a first video, and the apparatus further comprises:
a sixth permission authorization module configured to receive an authorization by the first user to a fifth user for a permission to publish a video, wherein the first user and the fifth user belong to a same entity;
a third video receiving module configured to receive a second video published by the fifth user; and
a third video association module configured to, if the second video is published by the fifth user on behalf of the first user, associate the second video with the first user.

Example 24. The apparatus according to any of examples 13-23, further comprising:
a third video sending module configured to send the first video and the second video to the video aggregation page, enabling both the first video and the second video to present as videos published by the first user.

Example 25. An electronic device, comprising:
a processor; and
a memory coupled to the processor, the memory having instructions stored therein, the instructions, when executed by the processor, causing the electronic device to perform actions, the actions comprising:
receiving an authorization by a first user to a second user for a permission to publish a video, wherein the first user and the second user belong to a same entity;
receiving a video published by the second user; and
in response to the received video being published by the second user on behalf of the first user, associating the received video with the first user.

Example 26. The electronic device according to example 25, wherein the authorization for the permission to publish the video is received from a first client of the first user, the video published by the second user is received from a second client of the second user, and the actions further comprise:
sending the video published by the second user to a third client of a third user, for enabling the video published by the second user to present on a home page of the first user in the third client of the third user.

Example 27. The electronic device according to any of examples 25-26, the actions further comprising:
receiving an authorization by the first user to the second user for a permission to reply to a private message;
receiving a private message associated with the video published by the second user;
sending a task for replying to the private message to the second client;
receiving a reply to the private message by the second client from the second user; and associating the reply in the private message with the first user.

Example 28. The electronic device according to any of examples 25-27, the actions further comprising:
receiving a request from the third user to join a group associated with the video published by the second user; and
adding the first user, the second user, and the third user to the group.

Example 29. The electronic device according to any of examples 25-28, the actions further comprising:
receiving an indication that the third user likes the video published by the second user; and
pushing another video published by the second user to the third user.

Example 30. The electronic device according to any of examples 25-29, the actions further comprising:
receiving an authorization by a fourth user of the entity for maintaining the third user; and
enabling the fourth user to maintain the interaction between the first user and the third user.

Example 31. The electronic device according to any of examples 25-30, the actions further comprising:
receiving an authorization for setting the first user as an administrator of the entity; and
setting the first user as the administrator of the entity, wherein the administrator has a permission to set a user as a member of the entity, a permission to remove a user from the entity, and a permission to modify a permission of the user in the entity.

Example 32. The electronic device according to any of examples 25-31, the actions further comprising:
in response to the authorization for the permission to publish the video having expired, sending an expiration prompt to at least one of the first user and the second user.

Example 33. The electronic device according to any of examples 25-32, the actions further comprising:
receiving an authorization by the first user to the second user for a permission to edit a video;
receiving an editing operation on the video from the second user; and
updating information of the video according to the editing operation.

Example 34. The electronic device according to any of examples 25-33, the actions further comprising:
publishing the video in a video aggregation page, wherein the video aggregation page includes an introduction to the entity and a video collection.

Example 35. The electronic device according to any of examples 25-34, wherein the video published by the second user is a first video, and the actions further comprise:
receiving an authorization by the first user to a fifth user for a permission to publish a video, wherein the first user and the fifth user belong to a same entity;
receiving a second video published by the fifth user; and
if the second video is published by the fifth user on behalf of the first user, associating the second video with the first user.

Example 36. The electronic device according to any of examples 25-35, the actions further comprising:
sending the first video and the second video to the video aggregation page, for enabling both the first video and the second video to present as videos published by the first user.

Example 37. A computer-readable storage medium having one or more computer instructions stored thereon, wherein the one or more computer instructions are executed by a processor to implement the method according to any of examples 1 to 12.

Example 38. A computer program product being tangibly stored on a computer-readable medium and including computer-executable instructions, the computer-executable instructions, when executed by a device, causing the device to perform the method according to any of examples 1 to 12.

Although the present disclosure has been described in a language specific to structural features and/or logical actions of the method, it should be understood that the subject matter specified in the appended claims is not necessarily limited to the specific features or actions described above. Rather, the specific features and actions described above are merely exemplary forms of implementing the claims.

1. A method for video permission management, comprising:
receiving an authorization by a first user to a second user for a permission to publish a video, wherein the first user and the second user belong to a same entity;
receiving a video published by the second user; and
in response to the received video being published by the second user on behalf of the first user, associating the received video with the first user.

2. The method according to claim 1, wherein the authorization for the permission to publish the video is received from a first client of the first user, the video published by the second user is received from a second client of the second user, and the method further comprises:
sending the video published by the second user to a third client of a third user, for enabling the video published by the second user to present on a home page of the first user in the third client of the third user.

3. The method according to claim 2, further comprising:
receiving an authorization by the first user to the second user for a permission to reply to a private message;
receiving a private message associated with the video published by the second user;
sending a task for replying to the private message to the second client;
receiving a reply to the private message by the second client from the second user; and
associating the reply in the private message with the first user.

4. The method according to claim 2, further comprising:
receiving a request from the third user to join a group associated with the video published by the second user; and
adding the first user, the second user, and the third user to the group.

5. The method according to claim 4, further comprising:
receiving an indication that the third user likes the video published by the second user; and
pushing another video published by the second user to the third user.

6. The method according to claim 5, further comprising:
receiving an authorization by a fourth user of the entity for maintaining the third user; and
enabling the fourth user to maintain the interaction between the first user and the third user.

7. The method according to claim 1, further comprising:
receiving an authorization for setting the first user as an administrator of the entity; and
setting the first user as the administrator of the entity, wherein the administrator has a permission to set a user as a member of the entity, a permission to remove a user from the entity, and a permission to modify a permission of the user in the entity.

8. The method according to claim 1, further comprising:
in response to the authorization for the permission to publish the video having expired, sending an expiration prompt to at least one of the first user and the second user.

9. The method according to claim 1, further comprising:
receiving an authorization by the first user to the second user for a permission to edit a video;
receiving an editing operation on the video from the second user; and
updating information of the video according to the editing operation.

10. The method according to claim 1, further comprising:
publishing the video in a video aggregation page, wherein the video aggregation page includes an introduction to the entity and a video collection.

11. The method according to claim 10, wherein the video published by the second user is a first video, and the method further comprises:
receiving an authorization by the first user to a fifth user for a permission to publish a video, wherein the first user and the fifth user belong to a same entity;
receiving a second video published by the fifth user; and
in response to the second video being published by the fifth user on behalf of the first user, associating the second video with the first user.

12. The method according to claim 11, further comprising:
sending the first video and the second video to the video aggregation page, for enabling both the first video and the second video to present as videos published by the first user.

13. (canceled)

14. An electronic device, comprising:
a processor; and
a memory coupled to the processor, the memory having instructions stored therein, the instructions, when executed by the processor, causing the electronic device to:
receive an authorization by a first user to a second user for a permission to publish a video, wherein the first user and the second user belong to a same entity;
receive a video published by the second user; and
in response to the received video being published by the second user on behalf of the first user, associate the received video with the first user.

15. A non-transitory computer-readable storage medium having computer-executable instructions stored thereon, wherein the computer-executable instructions are executed by a processor to:
receive an authorization by a first user to a second user for a permission to publish a video, wherein the first user and the second user belong to a same entity;
receive a video published by the second user; and
in response to the received video being published by the second user on behalf of the first user, associate the received video with the first user.

16. The device according to claim 14, wherein the authorization for the permission to publish the video is received from a first client of the first user, the video published by the second user is received from a second client of the second user, and the device is further caused to:
send the video published by the second user to a third client of a third user, for enabling the video published by the second user to present on a home page of the first user in the third client of the third user.

17. The device according to claim 16, the device is further caused to:
receive an authorization by the first user to the second user for a permission to reply to a private message;
receive a private message associated with the video published by the second user;
send a task for replying to the private message to the second client;
receive a reply to the private message by the second client from the second user; and
associate the reply in the private message with the first user.

18. The method according to claim 16, the device is further caused to:
receive a request from the third user to join a group associated with the video published by the second user; and
add the first user, the second user, and the third user to the group.

19. The device according to claim 18, the device is further caused to:
receiving an indication that the third user likes the video published by the second user; and
pushing another video published by the second user to the third user.

20. The device according to claim 19, the device is further caused to:
receive an authorization by a fourth user of the entity for maintaining the third user; and
enable the fourth user to maintain the interaction between the first user and the third user.

21. The device according to claim 14, the device is further caused to:
receive an authorization for setting the first user as an administrator of the entity; and
set the first user as the administrator of the entity, wherein the administrator has a permission to set a user as a member of the entity, a permission to remove a user from the entity, and a permission to modify a permission of the user in the entity.
